(19) United States
(12) Patent Application Publication
(10) Pub. No.: US 2011/0049290 A1
(43) Pub. Date: Mar. 3, 2011

(54) METHOD OF PILOTING A ROTARY-WING DRONE WITH AUTOMATIC STABILIZATION OF HOVERING FLIGHT

(75) Inventors: Henri Seydoux, Paris (FR); Martin Lefebure, Courbevoie (FR); Francois Callou, Paris (FR); Claire Jonchery, Paris (FR); Jean-Baptiste Lanfrey, La Garenne-Colombes (FR)

(73) Assignee: PARROT, Paris, FR (FR)

(21) Appl. No.: 12/865,355

(22) PCT Filed: Jan. 21, 2009
(86) PCT No.: PCT/FR09/00060

§ 371 Date: Nov. 18, 2010

(30) Foreign Application Priority Data
Feb. 13, 2008 (FR) 0800768
Jan. 21, 2009 (FR) PCT/FR2009/000060

(51) Int. Cl. G05D 1/08; H04N 7/18; B64C 27/04; B64C 19/00

(52) U.S. Cl. 244/17.13; 348/114; 348/E07.085

(57) ABSTRACT

This method, applicable in particular to radio-controlled toys comprises the operations consisting in: fitting the drone with a telemeter and a video camera; acquiring the altitude of the drone relative to the ground by means of a telemeter; acquiring the horizontal speed of the drone; and automatically stabilizing the drone in hovering by: servo-controlling the vertical thrust force of the drone so as to stabilize the altitude acquired by the telemeter; and servo-controlling the horizontal thrust force of the drone so as to obtain zero horizontal speed. The video camera is a front-sight camera pointing towards the front of the drone; and the horizontal speed of the drone is acquired from a plurality of video images captured by said front-sight camera.

The present invention relates to a method of automatically stabilizing hovering flight of a rotary-wing drone. It also applies to a method of piloting the drone.

A particularly advantageous application of the invention lies in the field of radio-controlled toys suitable for use by children, in particular in indoor environments, such as in a room in a house or an apartment, for example.

The term “rotary-wing drone” is used herein to cover any known helicopter formula, i.e. the conventional single-rotor formula with an anti-torque tail rotor; the banana-shaped twin-rotor tandem formula; the “Kamov” formula having contrarotating coaxial rotors, and the quadricopter formula having four fixed-pitch rotors, etc.

The drone has an on-board computer and an inertial unit fitted with numerous sensors, such as gyros (rate gyros or free gyros), accelerometers, altimeters, Pitot tubes, global positioning system (GPS) receivers, etc.

It is appropriate to begin by recalling what is required for piloting a rotary-wing aircraft. By way of example, we refer to the stages of takeoff, landing, hovering flight, and flight in translation.

For takeoff, the ground effect significantly modifies flight reactions because the column of air driven by the main rotor can no longer flow away freely, but is deflected by the ground. The performance of the rotor thus differs depending on the altitude of the helicopter. Since a cushion of air under increased pressure is created close to the ground, the aircraft tends to take off easily and requires a different throttle setting in order to maintain hovering flight close to the ground. There are also oscillating effects that exist between the ground and the various vortices generated by the rotor.

Hovering flight involves stabilizing the helicopter. Since the center of gravity of the aircraft is variable, the pilot needs to perform compensation adjustments after take off, as is also necessary with an airplane (which adjustments are referred to below by the common term “trim adjustments”) to ensure that when the flight controls are in the neutral position they do not cause the aircraft to move up or down.

When landing, the throttle needs to compensate the ground effect and the large variation in the efficiency of the rotor close to the ground. The throttle must therefore be piloted with care in order to ensure a landing that is gentle.

Hovering flight is difficult to obtain. It is necessary simultaneously to servo-control the power of the rotor so as to conserve an altitude that is constant, to compensate the torque from the main rotor, and to keep the cyclic pitch in neutral in order to avoid being diverted to left or to right.

In addition to coordinating all of the controls, it is also necessary to compensate external effects such as wind, that might be steady or gusty.

Maintaining good hovering flight is very difficult for a novice helicopter pilot. When the equilibrium point is reached, it is never perfect, so it is also necessary to trim the helicopter continuously to a small extent, i.e. to keep returning to the fixed point by correcting for small variations of movement in translation along any of the axes.

Finally, the mechanics of flight in translation are different from the mechanics of the other stages of flight under discussion. When moving forwards, the centrifugal force due to turning needs to be compensated, as with a bicycle or an airplane, by tilting the aircraft.

For a conventional helicopter, another problem arises that is associated with the fact that the advancing blade of the rotor generates more lift than does the retreating blade. This needs to be compensated by the cyclic pitch of the aircraft.

It can thus be seen that piloting a helicopter presents many difficulties. These difficulties are made worse when the helicopter is a radio-controlled scale model from which the operator receives no force return. The operator must be satisfied with seeing the aircraft and accessing its position in three dimensions. This means that it is necessary to have very good knowledge of the physics of flight in order to be capable of interpreting the position in three dimensions and understanding what actions need to be performed in order to reach the point of equilibrium.

It is thus very difficult for an untrained person to stabilize a rotary-wing drone using conventional commands based on levers acting on throttle, roll, pitch, and yaw.

Moreover, training in a simulator takes several hours, which means that most people have no opportunity to pilot such aircraft. Furthermore, even for people who have been trained by means of a simulator or who regularly fly such radio-controlled aircraft, there exist risks of an accident when the drone is moving in a confined environment.

The difficulty stems from the fact that in the absence of expert manual control or specific servo-control, this type of aircraft is unstable. It is difficult to achieve accurate and continuous balancing between the forces involved, namely thrust from the wing and the force of gravity. Furthermore, flight dynamics are complex since they associate acceleration in addition to external forces with the linear and angular speeds of the aircraft and the thrust from its wing.

Drones are fitted with inertial sensors, such as accelerometers and gyros as fitted to drones, and they do indeed serve to measure the angular speeds and the attitude angles of an aircraft with some degree of accuracy. They can therefore advantageously be used dynamically to servo-control the direction of the thrust from the aircraft so that it is in a direction opposite to the direction of gravity. Nevertheless, a difficulty arises in that such measurements are performed in the frame of reference of the sensors and it generally remains necessary to perform angle corrections in order to transpose them into the frame of reference of actuators. Furthermore, the real center of gravity may be offset from the theoretical center of gravity. Unfortunately, it is at the center of gravity that it is necessary to balance the forces applied to the aircraft. These differences between theory and reality may be corrected using so-called “trim” angles. Such trimming or stabilization maybe performed by servo-control at a zero horizontal speed since the aircraft then accelerates systematically in the direction that is associated with the trim error.

Thus, during a trimming stage or in order to establish hovering flight, the problem consists in reducing the linear speed of the aircraft to zero by appropriate servo-control of its actuators.

For this purpose, it is necessary to have at least one indication of the direction and the amplitude of the speed of horizontal movement. Unfortunately, inexpensive accelerometers generally present bias that is variable, thereby making it impossible to deduce the linear speed of the aircraft with sufficient accuracy.

A first object of the invention is to remedy that difficulty by proposing effective and inexpensive means for acquiring the horizontal speed of the drone, so as to enable it to be stabilized automatically in the horizontal plane in hovering flight.

Essentially, the invention proposes using the video camera with which the drone is already fitted (for piloting at sight and for recognizing the scene in front of the drone) in order to deduce the direction and the amplitude of the linear speed of the aircraft on the basis of the movements of shapes as detected and tracked between successive images.

A vision camera is described for example in WO 01/87446 A1, which discloses a drone fitted with a “microcamera” providing images that are transmitted to a remote pilot and that are used exclusively for forming an image of the scene, in particular for remote inspection of components or works that are situated high up and that are difficult to access. That microcamera has no purpose other than displaying an image, and there is no suggestion that the image should be used for other purposes, and a fortiori for functions of stabilizing the drone, where such stabilization is performed by a gyroscopic effect using a flywheel on board the drone.

The starting point of the invention is the use of a preexisting vision camera, typically a wide-angle camera, that points towards the front of the aircraft and that delivers an image of the scene towards which the aircraft is heading. This image, initially intended for enabling a remote pilot to pilot at sight, is used to reconstitute information about the horizontal speed of the aircraft on the basis of successive transformations of the image of the scene captured by the camera.

Drones already exist that use cameras for stabilization purposes, e.g. as described in US 2005/0165517 A1. That document discloses a system of piloting and stabilizing an aircraft using, amongst other things, a camera or a set of cameras. However those cameras are specialized cameras, and in addition they point to the ground. Changes in the attitude of the aircraft are evaluated in order to stabilize it about various axes, with movement being measured by technology comparable to that used for optical computer mice.

In contrast, one of the objects of the invention is to avoid having recourse to a specialized camera, with the direction and the amplitude of the linear speed of the drone being deduced from the movements of shapes as detected and tracked between successive images.

This different approach does indeed require resolution (in numbers of pixels) that is much greater than that needed for the technology described by document US 2005/0165517 A1, however insofar as the camera exists already for another function, this condition is not a drawback.

An object of the invention is thus to be able to trim the aircraft and achieve hovering flight using inexpensive conventional sensors such as accelerometers, gyros, and an ultrasound telemeter, together with a preexisting video camera, and to do so in a manner that is completely self-contained, even in an indoor environment such as a room in a house or an apartment.

Another object of the invention is to propose a method that thus enables people with no piloting experience, in particular children, nevertheless to pilot a rotary-wing drone without needing to act directly on flight parameters, such as throttle power, by using conventions controls with levers, and instead to perform piloting in intuitive manner in terms of horizontal and vertical movements.

In accordance with the invention, the above objects are achieved by a method of piloting a rotary-wing drone with automatic stabilization of hovering, the method comprising the steps consisting in: fitting the drone with a telemeter and a video camera; acquiring the altitude of the drone relative to the ground by means of a telemeter; acquiring the horizontal speed of the drone; and automatically stabilizing the drone in hovering by: servo-controlling the vertical thrust force of the drone so as to stabilize the altitude acquired by the telemeter; and servo-controlling the horizontal thrust force of the drone so as to obtain zero horizontal speed.

In a manner characteristic of the invention, the video camera is a front-sight camera pointing towards the front of the drone; and the horizontal speed of the drone is acquired from a plurality of video images captured by said front-sight camera.

Advantageously, the method of the invention further includes the operations consisting in defining elementary piloting functions, each elementary piloting function being suitable for determining flight parameters to be executed by a set of actuators of said drone so as to perform said elementary piloting function; providing a user with activation means for activating said elementary piloting functions; and the user piloting the drone by actuating said activation means for activating elementary piloting functions, with the drone being placed automatically in stabilized hovering flight whenever no function is being activated.

In particular, the invention provides for said elementary piloting functions to comprise the following actions: move up; move down; turn right; turn left; move forwards; reverse; move left in horizontal translation; move right in horizontal translation.

The activation means may be constituted by keys of a piloting box or by traces drawn by a stylus on a touch-sensitive surface of a piloting box.

The piloting method of the invention thus relies on completely redefining the piloting controls and maneuvers: in the prior art, piloting maneuvers are constituted by various actions that the operator needs to perform on lever controls in order to modify certain flight parameters, such as collective pitch, cyclic pitch, pitch of the anti-torque tail rotor, and engine power, while here they are replaced by overall elementary functions that are completely intuitive for the operator. These functions are executed by the on-board computer taking the place of the operator to control the appropriate actuators of the drone so as to modify automatically the corresponding flight parameters accordingly.

For example, in order to perform the “move up” function, it suffices for the user to activate this function by pressing on the corresponding key of the piloting box, without the user actually controlling engine power. It is the on-board computer that does that automatically, and that also modifies collective pitch and corrects stability by adjusting the tail rotor.

The piloting controls with levers that are usually used are eliminated and replaced by function activation means that are much more familiar, in particular for children, i.e. keys analogous to those that already exist on video games consoles, or traces drawn by a stylus on a touch-sensitive surface.

An important characteristic of the invention is that the drone is piloted on the basis of a basic elementary function that is stabilized hovering, this function being achieved very simply without requiring any particular activation means, key, or trace. In the absence of any activation of a key or a trace, the drone automatically takes up stable hovering flight. More precisely, when the user releases all of the controls, the on-board computer organizes movement in translation to go from the state in which the drone found itself when the controls were released to a hovering flight stage. Once hovering flight has been achieved, and so long as the user does not activate any of the elementary functions available on the piloting box, the drone remains in hovering flight.

To summarize, instead of searching for an equilibrium point at each stage of piloting, which requires lengthy training, a child pilots a drone from equilibrium point to equilibrium point.

It should be observed that certain elementary functions may have an effect that is slightly different depending on the intended piloting mode.

Thus, the “turn left” function may cause the drone to turn about its main axis while it is in hovering mode. In contrast, while it is translation mode, as obtained while actuating simultaneously the “move forward” or “reverse” key, the “turn left” function has the effect of causing the aircraft to tilt towards the inside of the turn and to cause it to turn progressively about the turn axis.

Advantageously, the activation means are multi-action means suitable for engaging, setting, and stopping associated elementary piloting functions.

For example, if consideration is given to the “move up” elementary function, the fact of pressing on the corresponding key of the control box causes the drone to move, into a mode of moving in vertical translation at constant speed. If the operator releases and then immediately presses the same key again, the vertical speed is increased by one unit. Finally, if the key is released completely, the speed in vertical translation is reduced to zero.

The invention also provides for said activation means to include means for activating automatic sequences. In particular, said automatic sequences comprise the drone taking off and landing.

In this context, it should be observed that sequences may also be launched automatically under particular conditions. For example, the loss of the radio connection may give rise to a change to hovering flight followed by a return to the starting point using GPS coordinates in order to follow the trajectory in the opposite direction.

From the above, it can be understood that stabilized hovering flight constitutes the very basis of the piloting method of the invention. Thus, in order to obtain an aircraft that is very simple to pilot, it is appropriate for it to be possible to stabilize the drone automatically in hovering flight without it being necessary for the user to act directly on the flying parameters constituted by throttle power, roll, and pitch, and this specifically makes it possible for the system for acquiring and stabilizing horizontal speed to make use of the front-sight video camera that points towards the front of the drone.

The invention also provides a rotary-wing drone capable of implementing the method described above, the drone being of the type comprising: a telemeter and a video camera; means for acquiring the altitude of the drone relative to the ground by means of the telemeter; means for acquiring the horizontal speed of the drone; and a system for automatically stabilizing hovering, the system comprising: servo-control means for servo-controlling the vertical thrust force of the drone so as to stabilize the altitude acquired by the telemeter; and servo-control means for servo-controlling the horizontal thrust force of the drone so as to obtain zero horizontal speed.

This drone is remarkable in that the video camera is a front-sight video camera pointing towards the front of the drone; and the means for acquiring the horizontal speed of the drone are means for acquiring said speed from a plurality of video images captured by said front-sight camera.

The invention also provides an assembly for piloting a rotary-wing drone, the piloting assembly comprising a drone as described above in combination with a piloting box comprising means for activating elementary piloting functions; each elementary piloting function being suitable for determining flight parameters to be executed by a set of actuators of said drone so as to implement said elementary piloting function; and whenever no function is being activated the drone is placed automatically in stabilized hovering flight by means of the system for automatically stabilizing hovering flight of the drone.

Finally, the invention also provides a pilot control box as described above, as such.

There follows a description of an embodiment of the device of the invention, with reference to the accompanying drawings.

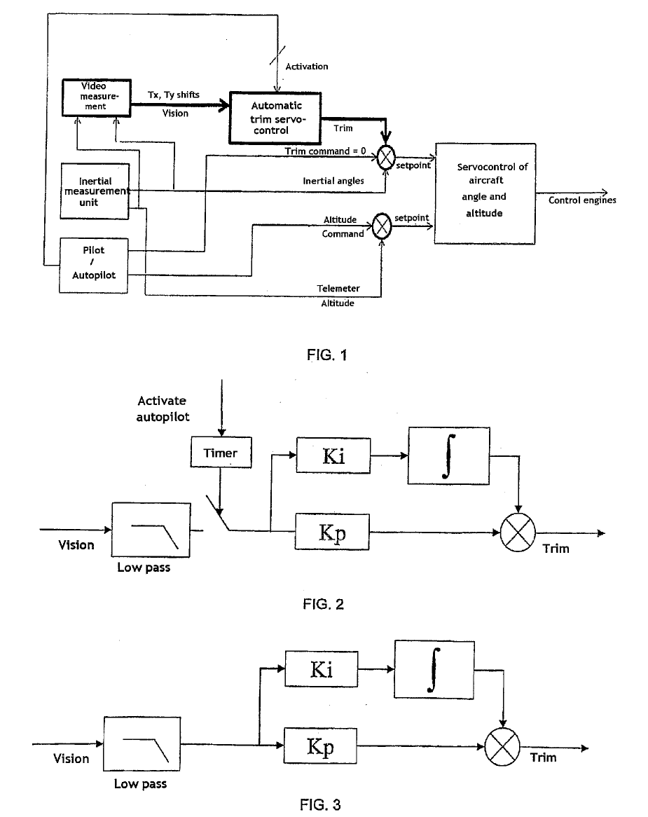

FIG. 1 is a diagram showing an automatic trim procedure.

FIG. 2 is a diagram of an automatic trim calculation circuit that is activatable with the help of a timer.

FIG. 3 is a diagram of the continuous automatic trim calculation.

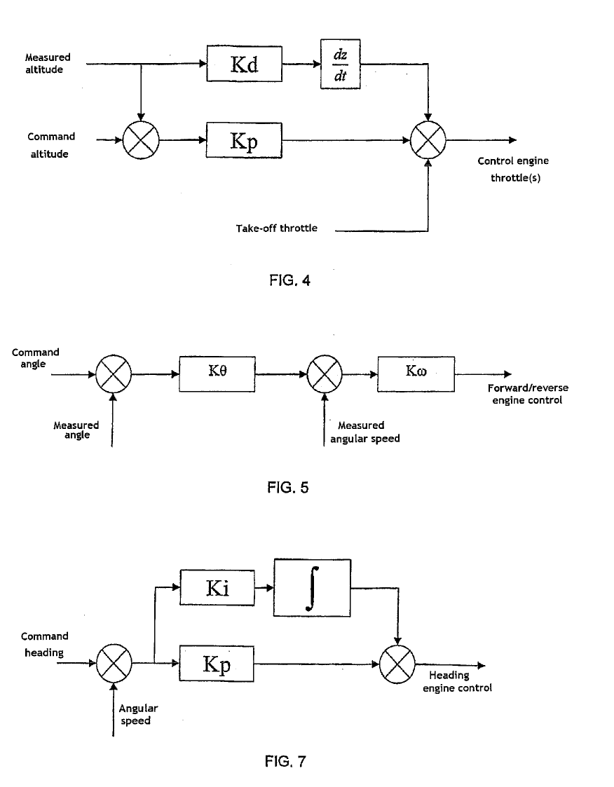

FIG. 4 is a diagram of a proportional-derivative corrector for altitude servo-control.

FIG. 5 is a diagram of a circuit for servo-controlling trim angle.

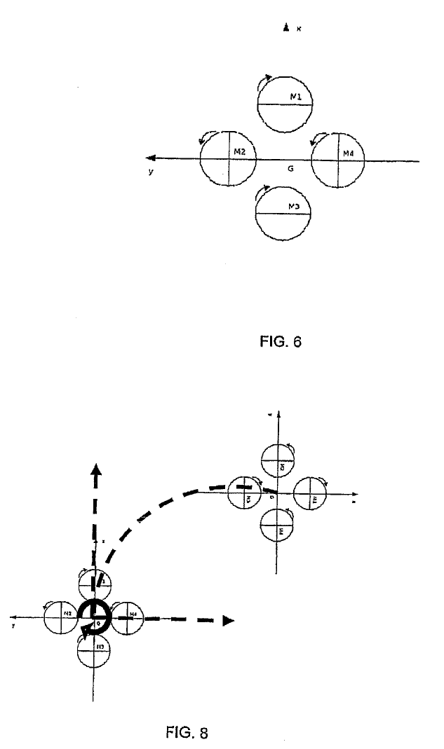

FIG. 6 is a diagrammatic plan view of the actuators of a quadricopter.

FIG. 7 is a heading servo-control circuit.

FIG. 8 is a diagram showing the FIG. 6 quadricopter moving forwards and turning.

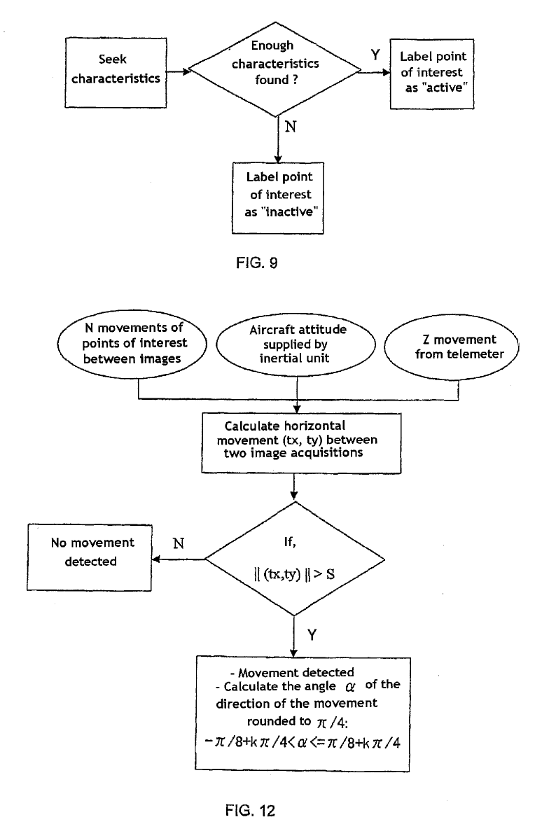

FIG. 9 is a diagram representing the initialization of points of interest in a method of extracting visual data for automatic trim and hovering flight.

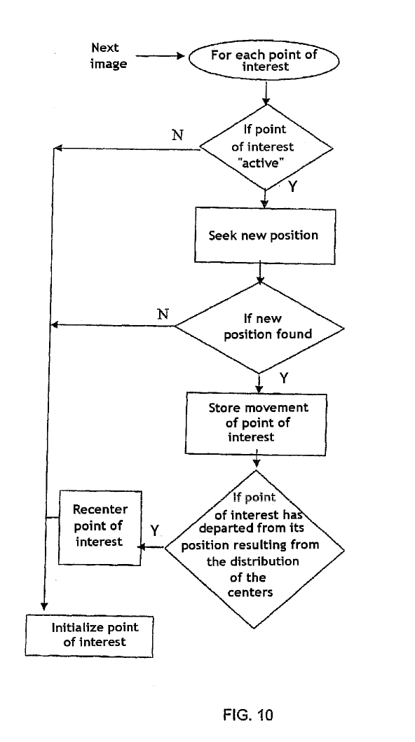

FIG. 10 is a diagram representing a procedure of detecting and tracking points of interest.

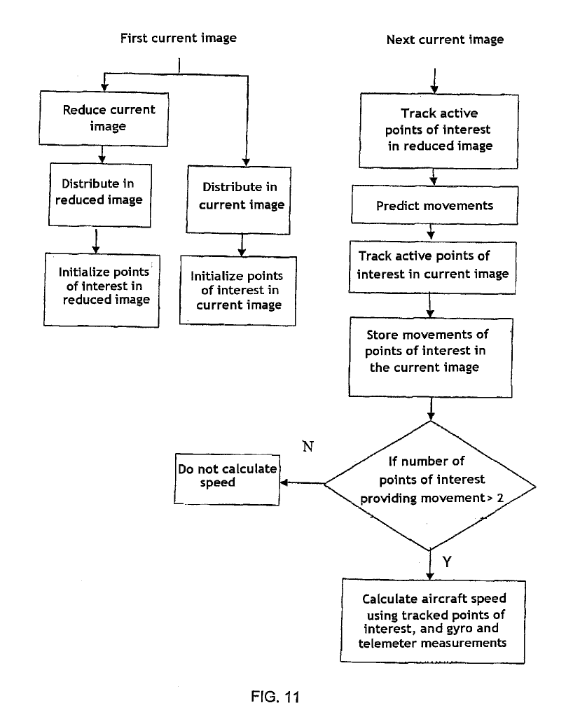

FIG. 11 is a diagram representing the multi-resolution approach to tracking points of interest.

FIG. 12 is a diagram for calculating the speed of the drone.

As mentioned above, the individual piloting functions of the method in accordance with the invention maybe activated by means of keys analogous to those that appear conventionally on video game consoles.

These keys include:
directional control keys for the up (Dh), down (Db), left (Dg), and right (Dd) directions;
action control keys for the up (Ah), down (Ab), left (Ag), and right (Ad), directions;
keys, also known as triggers, that are placed on the left (L) and right (R) sides of the console; and
“Start” and “Select” buttons.

The following correspondence table can thus be established between the activation keys and individual functions:

| | |
|---|---|
| Dh | Move forwards |
| Db | Reverse |
| L | Pivot left |
| R | Pivot right |
| Dg | Shift left |
| Dd | Shift right |
| Dg + Dh | Counterclockwise bicycle turn |
| Dd + Dh | Clockwise bicycle turn |
| Ah | Move up |
| Ab | Move down |

These individual function are associated with automatic sequences for takeoff and landing that are obtained using the “Start” key, for example.

It should be observed that the “Turn left” and “Turn right” functions are duplicated respectively as “Pivot left” and “Counterclockwise bicycle turn” and as “Pivot right” and “Clockwise bicycle turn”, where the “Pivot” function applies to hovering flight and the “Bicycle turn” function applies while moving in translation.

Naturally, any other correspondence relationships could be set up without going beyond the ambit of the invention.

As an indication, there follows a possible correspondence table between the individual functions and traces drawn with a stylus on a touch-sensitive surface:

| | |
|---|---|
| Upward trace from the center | Move forwards |
| Downward trace from the center | Reverse |
| Leftward trace from the center | Shift left |
| Rightward trace from the center | Shift right |
| Counterclockwise circular trace | Pivot left |
| Clockwise circular trace | Pivot right |
| Trace from center to top left corner | Counterclockwise bicycle turn |
| Trace from center to top right corner | Clockwise bicycle turn |
| Upward trace | Move up/takeoff |
| Downward trace | Move down |
| Downward trace followed by | Land |
| horizontal trace | |

In theory, an aircraft, in particular a rotary-wing drone, flying in a stationary mass of air requires a zero attitude command in order to remain in hovering flight, i.e. with level trim and no linear movement. In reality, its center of gravity may be offset relative to the positions of its sensors. Good knowledge of the center of gravity is, however, essential for balancing the forces that apply to the aircraft. Furthermore, the plane on which the sensors are placed may be different from the thrust plane of the actuators. Finally, mechanical dispersions mean that the engines or motors deliver thrusts that are not equal. To remedy those imperfections, it is necessary to bias the attitude measurement or setpoint of the aircraft that serves to maintain a flat trim.

This is implemented with the trim stabilization function.

The principle of automatic trim consists in adjusting the trim angles while hovering by using measurements from the view of a video camera, inertial measurements, and telemetry measurements.

The trim procedure consists in servo-controlling the drone to have zero horizontal linear speed in the X and Y directions with the help of measurements provided by the video camera, and zero vertical speed in the Z direction with the help of measurements provided by a telemeter, e.g. an ultrasound telemeter. The only action available on the aircraft is its angle of inclination in order to counter movement in translation. A first level of servo-control implemented with inertial measurements serve to place the aircraft with a 0° trim angle relative to the horizontal. Any movements that then remain are due to a trim error, which error is estimated visually, as shown in the diagram of FIG. 1.

Firstly, it is difficult to have quantified translation data when measurements are performed visually, in particular because of problems of estimating the ranges of the tracked points of interest. Furthermore, data from the visual surroundings may give rise to results that are discontinuous. In practice, vision supplies firstly information as to whether or not there is any movement by detecting that linear speed is greater than some threshold S (e.g. about 10 centimeters per second (cm/s)), and then only when the threshold is exceeded, does it supply the direction of the movement. This direction may be rounded to within π/4. Lowpass filtering serves to smooth the data and to escape from problems associated with temporary loss of tracking.

FIG. 2 is a diagram of a servo-control circuit for the aircraft in linear speed. The control relationship implemented has two components, namely a dynamic component that enables the movement of the aircraft to be countered, i.e. the proportional portion, and an integral component that serves to store the mean movement direction of the aircraft and provide the controls needed to counter this movement. The integral component on its own that calculates trim proper is not sufficient for stopping movement, since its response time is too long. It is therefore necessary to perform proportional control that gives pulses opposing movement.

As described in detail above, causes affecting trim are mainly mechanical and present little variation over time. By forcing the inputs to zero, the proportional portion remains at zero while the integral portion keeps a constant value. It is thus possible to store the mean value of the controlled trim. This value will remain constant during a flight of short duration. In addition, this makes it possible to avoid using vision which requires a large amount of central processor unit (CPU) time. Automatic trim is therefore activated during the takeoff procedure, and it is stopped at the end of a length of time that is predefined by a timer. In simulation on the selected aircraft, a trim having an angle of about 2° is achieved in 5 seconds and 15 seconds are required to achieve trim with a 4° angle.

The hovering flight procedure consists in servo-controlling the linear speed of the aircraft to be zero in the X and Y directions by means of measurements provided by vision, and in the Z direction by means of measurements provided by the telemeter. Hovering flight amounts to automatic trim being performed continuously. Only the deactivation by the timer is eliminated compared with the servo-control described above with reference to FIG. 2. This is shown in FIG. 3.

There follows a detailed description of how vertical movements are performed by the rotary-wing drone in accordance with the invention.

Two situations are possible for vertical control of the aircraft. If altitude data is not available, piloting assistance is not engaged and the user controls the engine power of the aircraft directly by means of the “Ah” and “Ab” keys. In contrast, when altitude data is available, the user makes use of simple commands of the “takeoff”, “land” type using the “Start” key, “climb x centimeters (cm)”, “descend x cm” using the “Ah” and “Ab” keys. The on-board software interprets these commands and servo-controls the altitude of the aircraft.

Automatic takeoff is performed by progressively opening the throttles with a predetermined slope until the aircraft takes off. Once the measured altitude is greater than a threshold, the throttle value as reached in this way is stored. Thereafter the aircraft is servo-controlled about this reference value.

Automatic landing takes place in two stages. Firstly the engine throttle control is decreased progressively so as to cause the aircraft to move downwards gently. Once a minimum altitude is reached, it is necessary to reduce the throttle control to a greater extent in order to counter the ground effect. The throttle is thus reduced following a steeper slope in order to set the aircraft down quickly. Once the aircraft has landed, the throttle is switched off.

During flight proper, once takeoff has been achieved, the user has two available vertical controls: “climb x cm” or “descend x cm”. The on-board software servo-controls the altitude of the aircraft about said setpoint altitude. Servo-control is performed with the help of a proportional-derivative (PD) corrector as shown in FIG. 4. The physical system corresponds in outline to double differentiation of altitude:

$$m \cdot \frac{d z}{d t} = weight + engine throttle control$$

In order to obtain a response that is both fast and presents little setpoint overshoot, it is necessary to transform this equation into a second order differential equation:

$$az + b \frac{d z}{d t} + c \frac{{d}^{2} z}{d {t}^{2}} = 0$$

That is why a PD corrector is used in which the derivative component is applied directly to the measurement (by simplifying the equations) so as to avoid introducing zeros in the closed loop transfer function and avoid having two adjustment parameters (damping, cutoff frequency).

Once the aircraft is tilted, the thrust force is no longer vertical and it is necessary to project it along the geographical vertical. It is therefore necessary to divide the engine control by cos θ. cos φ where θ and φ are the usual Euler angles.

Since horizontal movements are now involved, it is important to observe that with a rotary-wing drone, for example, the aircraft does not possess horizontal propulsion means, but only a vertical thrust force F_thrust. In order to move the aircraft, it is therefore necessary to tilt it so as to obtain a non-zero resultant in the horizontal plane. If the thrust plane makes an angle θ with the horizontal, then the resultant force of the thrust in the horizontal plane is F_thrust. sin(θ).

In straight line movement, use is made of angular speed measurements provided by gyros and of angle measurements obtained by merging accelerometer data and angular speeds. This serves to measure trim angles of the aircraft.

By reducing the thrust at the front compared with the thrust at the rear, the aircraft is caused to tilt and move forwards. The principle is the same for moving in reverse or sideways.

The servo-control selected as shown in FIG. 5 is servo-control with an internal loop for controlling angular speed ω and an external loop for controlling trim angles.

Pressing on the forward/reverse keys “Dh/Db” on the directional cross of the control box causes the drone to advance or reverse at a greater or lesser speed in a straight line.

Similarly, pressing for a greater or shorter length of time on the left and right sides “Dg/Dd” of the directional cross of the control box causes the drone to move sideways in a straight line to the left or to the right.

These key-presses may equally well be replaced by drawing a trace on a touch-sensitive surface. An upward trace from the center of longer or shorter length causes the drone to move forwards for a longer or shorter length of time. The same principle is applicable to all four directions.

Concerning movement in rotation about the vertical, this is achieved by measuring the speed of rotation of the drone about the vertical axis so as to cause it to pivot and thus control its heading.

For example, with the quadricopter of FIG. 6 that possesses four vertical thrust engines, two of which (M1, M3) rotate clockwise and two of which (M2, M4) rotate counterclockwise, by way of example, it can be observed that if the speed of rotation of the engines M1 and M3 is reduced relative to that of M2 and M4, then the drone will pivot clockwise. Under such circumstances, only an angular speed measurement is available. In order to avoid too great a drift in heading, a proportional/integral correcting servo-control circuit as shown in FIG. 7 is used.

By way of example, the user can control heading by means of the “L” and “R” keys of the control box. Pressing on the “R” key will cause the aircraft to pivot clockwise and on the “L” key to pivot counterclockwise.

On a touch-sensitive surface, tracing a circle clockwise will cause the aircraft to pivot clockwise and tracing a circle counterclockwise will cause the aircraft to pivot counterclockwise.

In order to ensure the aircraft points continuously in the travel direction, it is advantageous for the drone to pivot as it moves forwards and sideways. This is referred to as forward movement with bicycle turning. Pressing simultaneously on the forward and right keys “Dh” and “Dd” causes the aircraft to move forwards and to the right while also causing its heading to vary in the direction of the movement.

An example of such a movement is shown in FIG. 8 for a quadricopter.

Pressing simultaneously on the “Dh” and “Dd” keys delivers a forward movement setpoint, a right movement setpoint, and a speed of rotation for the heading in the clockwise direction.

Similarly, pressing on the “Dh” and “Dg” keys sends a forward movement setpoint, a leftward movement setpoint, and a heading speed of rotation in the counterclockwise direction.

On a touch-sensitive surface, traces from the center towards the top left or top right corners give rise to the same setpoints.

The servo-control used is the same as the servo-control shown in FIGS. 5 and 7.

There follows an explanation of a method of extracting visual data for use in automatic trim and hovering flight.

A first step of the method relates to detecting and tracking points of interest.

The principle of detection consists in placing points of interest in a uniform distribution in the image and in characterizing them by gradients that are significant.

In practice, in a square window of fixed size around each point of interest, a search is made for gradients of magnitude greater than a threshold.

If the magnitude of the gradient is much greater than the threshold, this gradient is given a greater weight in the list of characteristics of the points of interest in order to give advantage to highly significant contrasts. If gradients greater than the threshold are found in sufficient number, then the point of interest is said to be active: this is the initialization stage shown diagrammatically in FIG. 9.

An inactive point of interest is a point of interest for initializing in the following image, without it being possible to track it. Tracking an active point of interest in the following image consists in searching for the same gradient distribution, with some percentage of loss nevertheless being authorized. Assuming that the aircraft has moved little between two acquisitions, a search is made for the distribution from the preceding position of the point of interest, going away therefrom until the desired distribution is obtained (tracking successful) or until reaching a maximum authorized distance of movement in the image (tracking failed).

After tracking, the characteristics associated with a properly-tracked active point of interest are generally not recalculated, thereby limiting calculation time. Characteristics are initialized in only three circumstances in a new image: if tracking of a point of interest has failed; if the point of interest was inactive at the preceding initialization for lack of sufficient gradients; or if the point of interest has been tracked correctly but it is too far away from its initial position. It is then necessary to perform repositioning in order to maintain a uniform distribution of points of interest.

FIG. 10 is a diagram representing the general procedure for detecting and tracking points of interest.

In order to limit both the level of noise in the images, which are often of quality that is considered as being mediocre, and also the calculation time of the method, the original images are not used directly, but rather images are used that are of a size that has been reduced by a factor of four, which images are obtained by replacing blocks of a 2×2 size with the mean of the gray levels in each block. These images are referred to below as current images.

Still for the purpose of accelerating calculation, a multi-resolution approach is used for estimating the movements of points of interest from one image to another. The diagram of FIG. 11 illustrates this multi-resolution approach.

Thus, the current image being processed is one more reduced by a factor of 4 by averaging blocks of 2×2 size. The points of interest are placed and initialized and then they are tracked in the next reduced image, as described above. The advantage of working on a coarse version of the image lies in the fact that only a very small amount of movement is allowed in the image and as a result points are tracked very quickly. Once active points of interest have been tracked in the coarse image, the resulting movement information is used to predict the movement of the points of interest on the current image. In practice, for each active point of interest in the current image, a search is made for the tracked point of interest that is closest in the reduced image, after returning the reduced image to the current scale. A prediction of the movement of the active points of interest is deduced therefrom. Tracking is then refined by searching for the characteristics around the predicted position. Once more, only a small amount of movement is authorized for finding the characteristics.

The proposed tracking solution satisfies the following constraints: firstly, since no object model is used, the method adapts to any environment picked up by the camera, i.e. to scenes that might possibly present little structure, having few objects or presenting few singularities such as lines, edges, etc., as are required by certain conventional techniques based on shape recognition. In the present circumstances, there is no need for the image to contain precise shapes, it suffices to be able to recognize gradients present at a level that is greater than the level of noise.

Furthermore, since tracking is based on gradients, it is robust in the face of changes of illumination, due in particular to variations in lighting, in camera exposure, etc. Finally, by means of the multi-resolution approach and the principle of not recalculating characteristics when points of interest are tracked, the complexity of the method remains limited.

In order to increase the number of points of interest that are tracked, it is advantageous to cause the aircraft to turn and to climb or descend so that a sufficient number of points of interest are detected. This is essential for being able to implement automatic trim and hovering flight under good conditions on the basis of linear speed measurements deduced from camera images. Three methods have been developed, consisting in:
bringing the center of gravity of points of interest weighted by their ages towards the center of the image;
minimizing a cost function for the distance to the center of the detection zone of the points of interest; and
recentering points of interest that are far away towards the center of the image, whenever that is advantageous, otherwise recentering the center of gravity of the points of interest.

In the absence of points of interest, two methods are possible:
continuing in the most recently selected direction; and/or
waiting a little, and then selecting a direction at random, continuing, and selecting again.

Calculating the speed of the aircraft between two images on the basis of tracked points of interest is based on the following data:
the structure of the scene is unknown;
the movement of the aircraft between two image acquisitions is small, with image acquisition taking place at a frequency of 25 images per second;
the inertial unit provides the attitude of the aircraft in three dimensions;
little CPU time is available.

The movements of the points of interest between two images depend on the aircraft moving in rotation and in translation, and also on the distance, referred to as range, of the points as projected onto the image-forming plane. At a frequency that is greater than that of image acquisition, the inertial unit supplies three-dimensional attitude angles for the aircraft. By using the attitude angles at each image acquisition, it is possible, knowing the position and the orientation of the camera relative to the inertial unit, to deduce how much the camera has rotated between two acquisitions. Thus, it is possible to eliminate the effect of rotation by projecting the points of interest onto a common frame of reference, e.g. that of one of the two images. It is therefore necessary only to estimate movement in translation.

After this processing relating to N tracked points of interest between two images, 2N equations are obtained associating the coordinates of the points in the two images, the three components of the movement in translation, and the range of each of the end points as projected into the frame of reference of the camera before the movement. The amplitude of the movement in translation is very small and the movements of the points are noisy, at least as a result of sampling on the grid of pixels, with methods that estimate simultaneously the ranges of the points and the movements in translation giving results that are poor. Similarly, methods based on the epi-polar constraint require a large amount of movement in order to supply satisfactory results. That is why an assumption is proposed concerning ranges that is adapted to the specific features of the tracking method. The method relates more to tracking small plane zones from one image to another than to tracking precise points in three dimensions. Consequently, it is assumed that the filmed scene forms part of a plane parallel to the image plane and thus that all of the tracked points are at the same range: this assumption is made that much more valid when the movement is very small and the filmed objects are far from the camera. The 2N equations then have only three unknowns: the three components of the movement in translation relative to the range of the scene.

In order to estimate the movement in translation of the aircraft, an estimate is made initially of the movement in translation along the direction of the optical axis of the camera, making use of the distortions of shapes defined by the points of interest tracked between the images. Thereafter, on the basis of the estimate, movements in translation are calculated along the directions of the axes of the image by a least squares method. Finally, the estimated vector in the frame of reference of the camera is converted into the fixed three-dimensional frame of reference. Since the range of the scene in the camera is not known, the movement in translation is thus estimated to within a scale factor. Information is missing concerning the distance between the scene and the camera for use in estimating not only the direction of the movement in translation but also its amplitude. The telemeter may provide a measurement for translation along the axis Z: this can then be used to deduce the amplitude of the estimated translation vector.

In order to facilitate calculating movement in translation that is subject to numerical instabilities, the method of tracking and calculating movement in translation is applied to sequences that are under-sampled in time. Thus, points of interest are tracked and the corresponding speed is calculated over a plurality of sub-sequences extracted from an original sequence. This often improves results.

In order to calculate the movement in translation, another assumption has been considered as an alternative to that of constant range. The camera on board the aircraft can view the ground, so a corresponding assumption about ranges can be envisaged: it is assumed that the points projected on the image plane form part of the ground which is assumed to be flat. Given the orientation of the camera in three dimensions, the position of the camera on the aircraft, and the attitude of the aircraft in three dimensions, it is possible to project the points on a view of the ground and to calculate directly the movement in translation in the fixed three-dimensional frame of reference. Knowledge of the movement in translation along the axis Z then greatly facilitates calculation. However, in order for the projected points to be capable of satisfying this assumption, they need to be positioned in the bottom portion of the image, thereby limiting chances of placing them on existing contrasts, particularly since the bottom portion of the image often presents uniform textures (carpet, linoleum, . . . ), that are more difficult to track. That is why as an alternative to the assumption of flat ground, the assumption of a front scene enabling points for tracking to be placed over the entire image is also taken into consideration.

To achieve automatic trim or hovering, there is no need to provide the system with an estimate of the speed of the aircraft. Firstly, telemetry provides an estimate of vertical speed and a specific device for servo-controlling height makes use of this information. Secondly, the directional controls in the horizontal plane of the aircraft are eight in number (forwards/reverse, right/left, giving eight combinations), it suffices to provide an estimate of the direction of movement in translation in the horizontal plane selected from amongst eight possibilities. Thus, on the basis of the estimated movement in translation (tx, ty, tz) described above, it is possible to select as the direction of movement in the horizontal plane the direction amongst the eight directions that is closest to (tx, ty), only if the magnitude of the movement in translation (tx, ty) is significant, i.e. greater than a threshold S of a few millimeters.

Finally, in order to eliminate aberrant measurements produced by the method, measurements are supplied only if the number of points of interest that have been tracked with success between two images is strictly greater than two. Furthermore, if the estimated direction differs from the preceding estimated direction by an angle greater than or equal to 2π/3, the measurement is not taken into consideration.

FIG. 12 is a diagram summarizing the way the speed of the aircraft is calculated.

Finally, it should be observed that calculating the movement in translation by the above-described method is particularly simple and fast insofar as, firstly there is no need to estimate the structure of the scene, and secondly the calculation relies on closed formulae.

1. A method of piloting a rotary-wing drone with automatic stabilization of hovering, the method comprising the steps consisting in:
fitting the drone with a telemeter and a video camera;
acquiring the altitude of the drone relative to the ground by means of a telemeter;
acquiring the horizontal speed of the drone; and
automatically stabilizing the drone in hovering by:
servo-controlling the vertical thrust force of the drone so as to stabilize the altitude acquired by the telemeter; and
servo-controlling the horizontal thrust force of the drone so as to obtain zero horizontal speed;
the method being characterized in that:
the video camera is a front-sight camera pointing towards the front of the drone; and
the horizontal speed of the drone is acquired from a plurality of video images captured by said front-sight camera.

2. A method of piloting a drone with automatic stabilization according to claim 1, the method being characterized in that it further comprises the operations consisting in:
defining elementary piloting functions, each elementary piloting function being suitable for determining flight parameters to be executed by a set of actuators of said drone so as to perform said elementary piloting function;
providing a user with activation means for activating said elementary piloting functions; and
the user piloting the drone by actuating said activation means for activating elementary piloting functions, with the drone being placed automatically in stabilized hovering flight whenever no function is being activated.

3. A method of piloting a drone with automatic stabilization according to claim 2, wherein said elementary piloting functions comprise the following actions: move up; move down; turn right; turn left; move forwards; reverse.

4. A method of piloting a drone with automatic stabilization according to claim 3, wherein said elementary piloting functions also comprise: move left in horizontal translation; move right in horizontal translation.

5. A method of piloting a drone with automatic stabilization according to claim 2, wherein said activation means are constituted by keys of a piloting box.

6. A method of piloting a drone with automatic stabilization according to claim 2, wherein said activation means are constituted by traces drawn by a stylus on a touch-sensitive surface of a piloting box.

7. A method of piloting a drone with automatic stabilization according to claim 2, wherein said activation means are multi-action means suitable for engaging, setting, and stopping associated elementary piloting functions.

8. A method of piloting a drone with automatic stabilization according to claim 2, wherein said activation means also comprise means for activating automatic sequences.

9. A method of piloting a drone with automatic stabilization according to claim 8, wherein said automatic sequences comprise the drone taking off and landing.

10. A rotary-wing drone comprising:
a telemeter and a video camera;
means for acquiring the altitude of the drone relative to the ground by means of the telemeter;
means for acquiring the horizontal speed of the drone; and
a system for automatically stabilizing hovering, the system comprising:
servo-controlling the vertical thrust force of the drone so as to stabilize the altitude acquired by the telemeter; and
servo-controlling the horizontal thrust force of the drone so as to obtain zero horizontal speed;
the drone being characterized in that:
the video camera is a front-sight video camera pointing towards the front of the drone; and
the means for acquiring the horizontal speed of the drone are means for acquiring said speed from a plurality of video images captured by said front-sight camera.

11. A piloting assembly, characterized in that it comprises:
a rotary-wing drone according to claim 10; and
a piloting box comprising means for activating elementary piloting functions;
each elementary piloting function being suitable for determining flight parameters to be executed by a set of actuators of said drone so as to implement said elementary piloting function; and
whenever no function is being activated, the drone is automatically placed in stabilized hovering flight by means of the system for automatically stabilizing hovering flight of the drone.

12. A piloting box for a rotary-wing drone according to claim 10, said piloting box being characterized in that it comprises means for activating elementary piloting functions;
each elementary piloting function being suitable for determining flight parameters to be executed by a set of actuators of said drone so as to implement said elementary piloting function; and
whenever no function is being activated, the drone is automatically placed in stabilized hovering flight.
